(19) United States
(12) Patent Application Publication
(10) Pub. No.: US 2003/0163470 A1
(43) Pub. Date: Aug. 28, 2003

(54) Method and system for mailing an object

(76) Inventor: Donald Wadley, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/083,298

(22) Filed: Feb. 27, 2002

(51) Int. Cl. G06F 7/00

(52) U.S. Cl. 707/9

(57) ABSTRACT

A method and system for sending articles through a postal mailing system. A combination of database technology with postal mailing systems and methods of mailing articles to avoid mail fraud and ensure proper delivery of articles to be mailed. Also a combination of database technology with mailing systems and methods thereto to permit the activation or deactivation of an identifier so that a mail carrier would know whether postage charges will be honored. The method may include associating the addressee with an identifier, and enabling the identifier for use in a postal system. In yet another embodiment, the combination of modern database technology with mailing systems and methods thereto allows tracking of information associated with a variety of mailings, such as timing, location, response ratios, etc.

### TECHNICAL FIELD

The present invention relates generally to mailing systems and more particularly to methods and apparatus for use with mailing and postage.

### BACKGROUND ART

Postal systems are known in the art for providing a method for delivering packages, letters and other items to recipients. These recipients may be predetermined by the sender as in the case where mail is directed to a particular individual. Alternatively, the recipients may be varied and less specific as in the case where the sender uses a mass mailing to reach a large audience. Some mail systems employ a billing method and require that the sender or the recipient of the mail pay for the service of delivering the mail to the recipient thereof. This is the mail delivery system popularly used in the United States and serviced by the U.S. Postal Office. Other mail systems, such as a mail system used for interoffice mail delivery, may be funded by some sponsoring organization such as the company who owns and operates the office. In these systems, the company provides the entire system including personnel, mailboxes, and delivery vehicles for the mail delivery system.

Problems with presently available mailing systems include various opportunities for mail fraud. Where a mass mailing is included as an insert in a periodical, an individual may take the postage label affixed to the insert and make unauthorized uses of that postage label to send items through the mail.

### SUMMARY

In one embodiment, the present invention provides an article for use in a postal system with an identifier indicated on the article and an addressee indicated on the article. The identifier is such that it may alternate between being enabled and disabled in a database.

In another embodiment, the invention is a method for sending an article in a postal system. This method may include the step of causing an identifier to be associated with information in a database and the step of marking an article with the identifier. The method may also include the step of enabling the identifier after the occurrence of a predetermined event and the step of checking whether the identifier is enabled before delivering the article.

In another embodiment, the invention involves another method for sending an article in a postal system. In this embodiment the method may include the step of causing an identifier to be associated with address information in a database and the step of marking an article with the identifier. The method may also include the step of comparing the address information associated with the identifier with addressee information on the article before delivering the article.

In yet another embodiment the invention is a system for tracking an article having an identifier and a recipient address. The system may include a reader configured to read information from the article. The system may also include a database, including identifier data associated with at least one identifier. The system may also include some means for retrieving data from the database and reviewing the data.

### BRIEF DESCRIPTION OF THE DRAWINGS

Certain features of the present invention will become apparent to those skilled in the art from the following description with reference to the drawings, in which:

FIG. 1 is a flow diagram showing a method in accordance with one embodiment of the invention;

FIG. 2 is a flow diagram showing a method in accordance with another embodiment of the invention;

FIG. 3 is a block diagram in accordance with an embodiment of the invention; and

FIG. 4 depicts an article for use in accordance with principles of the present invention.

### DETAILED DESCRIPTION OF PREFERRED EMBODIMENTS

For simplicity and illustrative purposes, the principles of the present invention are described by referring mainly to various exemplary embodiments thereof. Although the preferred embodiments of the invention are particularly disclosed herein, one of ordinary skill in the art will readily recognize that the same principles are equally applicable to, and can be implemented in other systems, and that any such variation would be within such modifications that do not part from the true spirit and scope of the present invention. Before explaining the disclosed embodiments of the present invention in detail, it is to be understood that the invention is not limited in its application to the details of any particular arrangement shown, since the invention is capable of other embodiments. The terminology used herein is for the purpose of description and not of limitation.

In one embodiment, the present invention combines databases with postal mailing systems and methods of mailing articles to help avoid mail fraud and ensure proper delivery of articles to be mailed. In another embodiment, the combination of modern database technology with mailing systems and methods thereto allows the activation or deactivation of an identifier so that a mail carrier would know whether postage charges will be honored. In yet another embodiment, the combination of modem database technology with mailing systems and methods thereto allows tracking of information associated with a variety of mailings, such as timing, location, response ratios, response demographics, point of origin, shipping points (such that a record of a mailings locations is retained), etc.

In another embodiment, the addressee is checked against an identifier associated with the postage so that the package or letter reaches the correct destination. Alternatively, the postage mark might include an identifier such that when read, the mail may only be sent to a particular addressee.

Another feature of one embodiment of the present invention includes postal billing that is only due upon receipt or upon delivery of the letter or package. In this way, a magazine insert postal card would only be charged to the addressee upon delivery of the postal card.

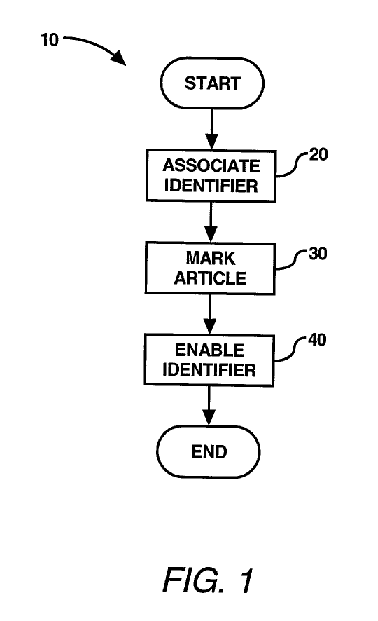

Referring to FIG. 1, a flow diagram is shown and depicts a method 10 for sending an article in a postal system in accordance with an embodiment of the invention. The method 10 includes the steps of creating 20 an identifier associated with an addressee or with some record in a database; marking 30 the article to be sent through the postal system with the identifier, and enabling 40 the identifier. The step of creating 20 an identifier may involve generating a unique identifier and associating the identifier with one or more records in an electronic database. Such records would preferably include a value or characteristic indicating that the identifier is either enabled or disabled. In one embodiment, this is achieved by including an indicator in a record associated with the particular identifier. The indicator is such that when the record is retrieved, the indicator returns a value showing the identifier as either enabled or disabled. The database may receive changes to the values in the database and/or act on instructions to change the status of the indicator for the record associated with a given identifier. A wide variety of other information may also be stored with the record or plurality of records associated with a given identifier. For instance, the information within a record may include a recipient address for delivery of any article marked with the identifier. The information may also include data indicating the source of the article, the cost of delivering the article, or sales information such as the date, time, and place of a particular article's sale. Such information may additionally include the article's weight, physical size, composition (e.g., package, envelope, postcard), a brief descriptor of the type of article enclosed (e.g., documents, floppy disks, tapes, etc.), and any known chemical properties of the article enclosed (e.g., radioactivity, biological agents, corrosiveness, flammability, health hazards, environmental hazards, whether the article is chemically neutral or inert), similarly a brief description of the article may be provided (e.g. plastic, metal, paper, rubber).

Thus a method, in accordance with an embodiment of the present invention, may include the steps of creating an identifier and optionally associating it with an addressee 20, marking the article to be sent through the mail 30, and enabling the identifier 40. In one embodiment, the identifier is associated with the addressee through a database. The step of enabling the identifier 40 may also make use of the database, by including an indicator with the identifier such that when a record for the identifier is retrieved, the database will return an indication that the identifier is enabled. The method may then involve comparing the values of the addressee information from the article to be mailed and the identifier record information retrieved from the database.

The step of marking 30 the article to be sent through the postal system with the identifier may take on a variety of different embodiments. The marking may be through any conventional marking means, including an alphanumeric sequence, a bar code, or some other graphic representation, such as a picture or encoded pattern. Preferably, the marking is either machine-readable or human-readable. Suitable machine-readable markings may include the use of radio-frequency identification (RFID) circuits or RFID tags. The identifier marked upon the article to be sent through the postal system may include a postage component that is readable by the postal authorities to be charged with delivery of the article.

In one embodiment, the step of enabling 40 the identifier is carried out as described above. Generally, however, the step of enabling 40 the identifier involves attributing a characteristic or value to the identifier such that when an inquiry is sent, the identifier will return a result indicating that the identifier is enabled or activated. Alternatively, the identifier may be disabled by attributing a characteristic or value to the identifier such that when an inquiry is sent, the identifier will return a result indicating that the identifier is disabled. It is to be understood that the identifier for a given article may preferably be enabled or disabled at any time, preferably any time prior to or during shipment of the article. In one embodiment, the identifier may be used to indicate whether a third party, which may include the sender or the recipient, will pay for charges associated with mailing the article, as well as any other amounts due from the postal carrier in association with delivery of the particular article. A postal carrier, such as the U.S. Postal Service, may check the identifier and determine whether they should deliver the article, based on whether the indicator has been enabled or disabled. In a preferred embodiment, the default indicator would be a disabled status, such that unless the indicator has been set to enabled status, the indicator returns a disabled value or other characteristic.

In one embodiment, the step of enabling 40 the identifier is not carried out until occurrence of some predetermined event. For instance, the database may be maintained in a system that is electronically linked, i.e., through a network, or Internet, or some other suitable mechanism, to a variety of vendors. As a vendor sells a given product, a signal is then sent to the database to enable or activate the identifiers appearing on various documents sold along with the product, such as warranty cards or product registrations. In this way, only the identifiers associated with products that have actually been sold may be used to send the warranty card or product registrations through the mail. Similarly, this technique might be used with inserts in periodicals, direct mail advertisements sent to random addresses, or even sent to specially selected addresses, as well as a variety of other mailings.

A final step in one embodiment would involve actually mailing the article, such as through the U.S. Postal System. This step may be completed by simply depositing the article with a suitable mail carrier. Alternatively, such a method might be employed with an internal mail system. This could be useful, for instance, within a company or other organization for internal delivery and organization of mail.

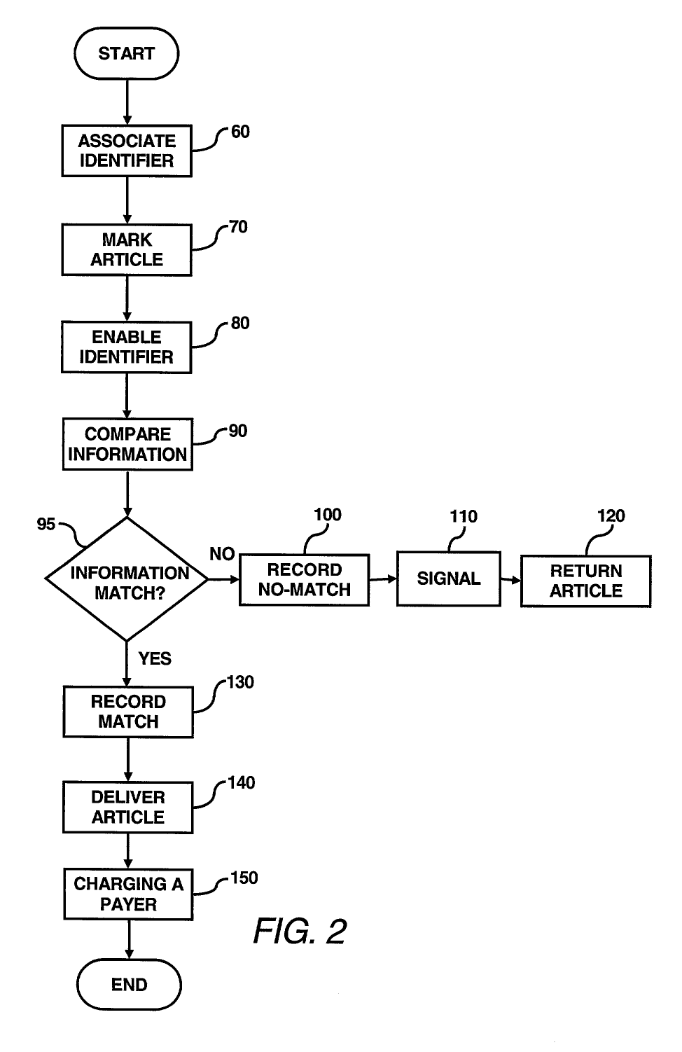

Referring to FIG. 2, a flow diagram depicts a method 50 in accordance with another embodiment of the invention. In this embodiment the method 50 is used in association with sending an article in a postal system. The method 50 includes the steps of associating 60 an identifier to one or more records in a database; marking 70 the article to be sent through the mail with the identifier; enabling 80 the identifier within a database; comparing 90 information retrieved from the database; recording 100 data in a database when the comparisons from the comparing 90 step do not match; returning 120 the article to the sender when the comparisons from the comparing 90 step do not match; recording 130 data in a database when the comparisons from the comparing 90 step do match; and delivering 140 the article to its intended recipient when the comparisons from the comparing 90 step do match.

In the method 50 depicted in FIG. 2, the step of associating 60, is similar to the creating 20 step of FIG. 1, however the associating 60 step does not involve generating a unique identifier, and is preferred for use with pre-existing identifiers. The steps of marking 70, and enabling 80 are conducted in a similar fashion to that described in association with FIG. 1. An additional step of comparing 90 information is included. In this step, information retrieved from the database records is compared or verified. The method may include verifying that the identifier has been enabled. This would include reading the identifier on the article to be mailed. The information from the records associated with that identifier is then retrieved and reviewed to determine whether it indicates that the identifier associated with those records has been enabled. Preferably, only a single record need be retrieved and reviewed to determine whether the identifier has been enabled.

The record may be or may simply include data. Thus, retrieval of the record may be achieved by any of the conventionally known methods of retrieving data from storage, including, without limitation, manual, automated, and electronic retrieval of data.

In another alternative, information retrieved from the record associated with a given identifier is compared against information on the article to be mailed, for instance, information indicating the mailing addressee. In accordance with this method, the postal service would only send the mail upon confirmation that the addressee substantially matches address information retrieved from the record associated with the identifier, or address information otherwise provided to the postal service for use with the identifier. In this way, an identifier can be associated with a particular mailing address such that the article will only be delivered if the identifier matches the mailing address appearing on the article. This could be used to avoid mail fraud, where a user improperly sends an article through a postal system and charges some third party for the fees.

Alternatively, the identifier may also be associated with a particular mailing address and an indicator such that the when the record is retrieved, the postal carrier would have instructions to send the article to a particular address, regardless of the addressee information appearing on the article. Again, this method could help to prevent instances of mail fraud.

Where comparing 90 step results do not match (as determined in step 95), the method 50 may include a recording step 100. This step could be used to record any information available about the mailing transaction and the article being sent through the postal system. Such information might include, but is not limited to, the date of mailing, the location or source of the article, the intended destination of the article, or other information. This information might then later be used to determine the source of articles with identifiers having database information that does not match the information upon the article, such as the sender or intended recipient.

The recording step 100 may also include a signal step 110 wherein a no-match signal is sent to a controller. Alternatively, this signal step 110 may be included as its own separate step, or it may replace the recording step 100.

Where the comparing 90 step results do not match (as determined in step 95), the method 50 may include a returning 120 step. In this step the article is returned to the sender or sent to some other predetermined location. In this way, those articles whose identifiers have not been enabled or activated, or whose identifiers return addressee information that varies from the information appearing upon the article itself, will not be mailed. The ultimate result is reduced mailing costs for the recipient or other party bearing the mailing costs.

Where the comparing 90 step results do match (as determined in step 95), the method 50 may include a recording 130 step. This step could be used to record any information available about the mailing transaction and the article being sent through the postal system. Such information might include, but is not limited to, the date of mailing, the location or source of the article, the intended destination of the article, or other information. This information might then later be used to determine the source of articles with identifiers having database information that does match the information upon the article, such as the sender or intended recipient.

The recording step 130 may also include a return step (not shown) wherein a match signal is sent to a controller. Alternatively, this return step (not shown) may be included as its own separate step, or it may replace the recording step 130.

Where the comparing 90 step results do match (as determined in step 95), the method 50 may include a delivering 140 step. In this step, the article is delivered to the recipient as indicated on either the article itself or an address indicated within the record associated with the identifier. In this way, only those articles whose identifiers have been enabled or activated, or whose identifiers return addressee information that substantially matches the addressee information appearing upon the article itself, will be mailed. The ultimate result is reduced mailing costs for the recipient or other party bearing the mailing costs and assurance that only properly addressed articles will be mailed.

In the method depicted in FIG. 2, steps 100 and 130 may alternatively be combined with other steps such as the comparing 90 information step. In such an embodiment, steps 100 and 130 might be performed in conjunction with reading the information from the article to be sent through the mail. In a preferred embodiment, steps 100 and 130 may be performed in conjunction with the comparing 90 information step, such that the results of the comparing 90 information step might also be recorded in a database or elsewhere. The steps of recording 100 and 130 may be considered part of the process of maintaining the database, to ensure that it reflects an accurate record of the traffic through the postal system, and a record of the articles that were improperly labeled, e.g., the number of times the information retrieved for the identifier did not match the information on the article to be mailed and associated details of each such instance. Alternatively, maintaining the database may include recording the number of times the information retrieved for the identifier did match the information on the article to be mailed and the associated details of each such instance.

It should be appreciated that the database would then hold a variety of useful information. Statistics could be generated showing the number of fraudulent mailings, or the response rate, as indicated by the ratio of mailings to purchased goods, or the ratio of mailings to printed response cards sent out, as in the case of direct mail. Yet another feature of one embodiment of the present invention includes a process and techniques to keep statistics on the postage or mailing. This would include, for instance, the total number of articles sent under a given number. These numbers could then be used, for instance, to determine response rate from a given audience.

An additional step may be added to either of the methods depicted in FIGS. 1 and 2, which includes the postal carrier charging a payer 150 for sending the article. In a preferred embodiment, this charge is only incurred upon the addressee's receipt of the article. This may include the addressee indicated upon the article itself, or an addressee indicated by the information retrieved from the record associated with an identifier upon the article. The payer may be any party willing to accept, or otherwise accountable for, the charges.

In another embodiment, the postage is only valid to be mailed to a specific predetermined address. This could be useful, for instance, in preventing mail fraud. This is especially true where the fraud exists in the form of users copying a postage identification and using it for personal or other unauthorized purposes.

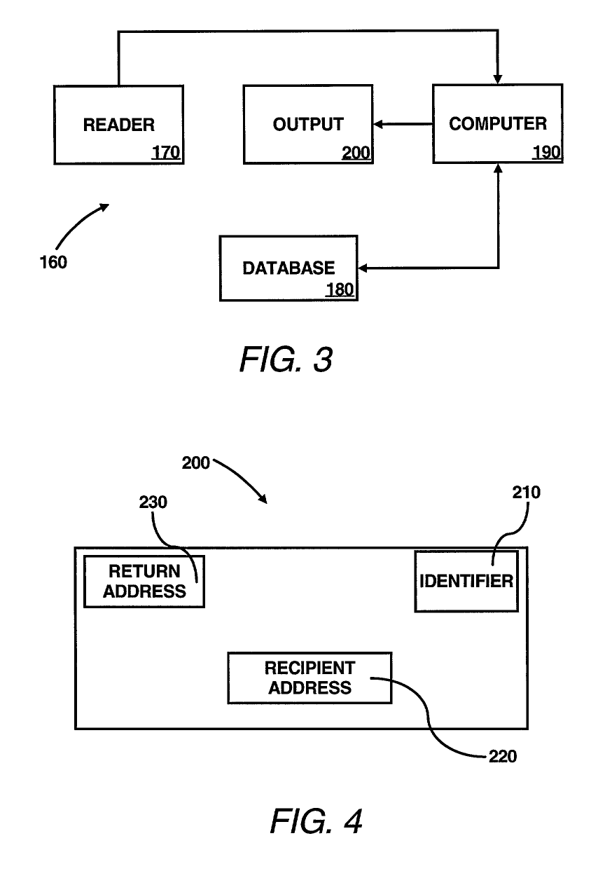

Referring to FIG. 3, a block diagram in accordance with another embodiment of the invention is depicted. In this embodiment, the invention relates to a system 160 for sending an article in a postal system. The article may be any of the previously-described types of articles. Preferably, the article has both an identifier and a recipient address. The identifier may be similar to that previously described. The system 160 comprises a reader 170, a database 180, and a computer 190 or other means for retrieving data from the database and reviewing the data. This means may include use of a computer, along with a network, Internet, or similar devices.

The system 160 is provided a reader 170 read the identifier within or upon the postage and then check the electronic database 180 to determine whether the identifier has been enabled. In one implementation, the system would enable the identifier upon purchase of a magazine which contains an article with the identifier marked thereon. In such instance, upon purchase of a particular magazine, or other periodical, a signal would be sent to the database 180 to change the status of the identifier from disabled to enabled, so that the inserts within the magazine could be mailed through a postal system. In this embodiment, the concept is that the postage is only valid once it has been enabled, or the identifier within that postage has been enabled. The article may also include an addressee indicator to indicate the recipient of the article. The database 180 may include identifier data and may relate one or more identifiers to one or more addresses. The system 160 may also include a means for comparing the addressee indicator on the article to be sent in the postal system against the identifier on the article to be sent in the postal system, such as a computer 190.

The system 160 employs the reader 170 to preferably read at least the identifier on the article to be mailed in a postal system. Preferably, the reader 170 also reads the recipient address. The reader 170 sends this information to the computer 190. In one alternative, the reader 170 may read information on the article relating to the article's source. The computer 190 may take this information from the reader and sort it for storing in one or more records associated with the identifier. Alternatively, information relating the article, and/or to the identifier may be entered into the database 180 directly from the computer 190, or from the Internet, or some other network. Such would be the case where the occurrence of some external event directs a change in the activation or enabled status of the identifier. In such instance, a signal may be sent directly to the database to modify one or more records to reflect this change in status.

The computer 190 retrieves data relating to the identifier from the article. This data may indicate whether or not the identifier has been enabled, it may also include data relating one or more recipient addresses to one or more identifiers for comparison against the recipient address read from the article, or it may include some other information. In one embodiment, the computer 190 retrieves the address data associated with the identifier in the database and compares it against the address data read from the article. The computer 190 reviews the data retrieved from the database 180 and preferably determines whether the identifier is enabled or activated. The computer 190 may also compare data from the database which includes recipient address information against the recipient address read off the article. The computer 190 is configured to determine whether or not to mail the article, on the basis of these reviews. The computer may also be configured to provide information relating to the computer's 190 analysis, to an output device 200.

As used herein, the term computer is intended to include any device for carrying out logical operations, including hardware, software, combinations of hardware and software, networks, the Internet, etc. Such a computer may include necessary hardware and software to temporarily or permanently store and modify information in a database, and later retrieve that information. The computer preferably includes means for enabling or activating an identifier. This includes means as previously described in FIG. 1, with regard to the step of creating an identifier. The computer would preferably not only include means for enabling or activating an identifier, but also for verifying the enablement of that identifier, or any other identifier in the database. This would include hardware and/or software to retrieve information (data) within the database that includes the identifier's enabled status, which is preferably either enabled or disabled, or activated or deactivated. The means for verifying enablement of an identifier would preferably also include the hardware and/or software necessary to review and interpret the information (data) retrieved from within the database.

In another embodiment, the system 160 also includes means for charging a payer upon delivery of the article to the recipient of the article. This may include the generation and sending of an invoice to the payer or customer, as well as the system, or determining the total cost of the delivery for a given article. The means includes any automated mechanism for charging a payer upon delivery of the article. In one embodiment, the system 160 records data within the database 180 to indicate that the delivery was completed. This data may or may not be associated with the identifier on the article. Preferably, the records for one or more of the identifiers can be retrieved and a determination made as to which of the articles associated with those identifiers have been delivered. The total cost of the delivery services may then be calculated based on the number of deliveries (and other data, e.g., the weight of the article, timing of the delivery, etc.) In another embodiment, the cost associated with the delivery may be calculated by the system at or prior to the delivery, and included within a record in the database associated with the article. This record may simply be retrieved at a later time and the cost determined in this manner. The means may also include hardware and/or software necessary to generate and send either a written or an electronic message conveying the total amount due to the payer or customer.

The system may include the hardware and/or software necessary to record a variety of different types of data with relation to the system's operation. This would include overall performance data, such as the number of articles being tracked, or in the system; where each of the articles is within the system; projected income from each, or a percentage of articles that have been delivered; and other similar data. The recordable data would preferably also include information about each particular article and the identifier associated therewith, as previously described.

FIG. 4 depicts yet another embodiment of the present invention. In this embodiment, an article 200 for use in a postal system includes both an identifier 210 and an addressee 220. The identifier 210 may be of any of the varieties previously described. The identifier 210 is preferably associated with one or more records in a database, such that other information about the identifier may be retrieved, modified, and/or supplemented, such as the appropriate recipient of the article 200, or whether the identifier 210 is enabled.

The article 200 also includes an addressee 220 to indicate the intended recipient of the article 200, such as that typically used for mailing packages and letters through the mail. This may consist of a name and a geographic location. In one alternative, the article 200 does not include an addressee 220. In such instance, the recipient information is stored in a database and may be retrieved by referencing the identifier 210 associated with the article 200.

Finally, the article 200 may include a field 230 for other information, such as the sender's identification, and return address. Thus, in one embodiment, the present invention provides an article 200 for use in a postal system with an identifier 210 indicated on the article 200 and an addressee 220 indicated on the article 200. The identifier 210 may serve as pre-printed postage and may be included for use on articles such as postal return cards, inserts in magazines, warranty cards, etc. The article 200 may be virtually any tangible item that may be shipped through the mail. The identifier 210 is preferably associated with an electronic database such that it may be enabled or disabled. When this identifier 210 is enabled, it is then valid (millions, or more, of mailing cards with these characteristics can be printed without actually paying for postage or incurring postage fees). The association between the identifier 210 and the electronic database may be such that the database includes records indexed to identifiers within the postage. These identifiers 210 may include varying levels of uniqueness, in accordance with the particular use to which the identifier is intended.

While the invention has been described with reference to certain exemplary embodiments thereof, those skilled in the art may make various modifications to the described embodiments of the invention without departing from the true spirit and scope of the invention. The terms and descriptions used herein are set forth by way of illustration only and not meant as limitations. In particular, although the present invention has been described by examples, a variety of devices would practice the invent concepts described herein. Although the invention has been described and disclosed in various terms and certain embodiments, the scope of the invention is not intended to be, nor should it be deemed to be, limited thereby and such other modifications or embodiments as may be suggested by the teachings herein are particularly reserved, especially as they fall within the breadth and scope of the claims here appended. Those skilled in the art will recognize that these and other variations are possible within the spirit and scope of the invention as defined in the following claims and their equivalents.

1. A method for sending an article in a postal system, said method comprising the steps of:
causing an identifier to be associated with information in a database;
marking an article with the identifier;
enabling the identifier after the occurrence of a predetermined event; and
checking whether the identifier is enabled before delivering the article.

2. The method of claim 1, wherein the identifier serves as postage for the article such that the article is only delivered when the identifier is enabled.

3. The method of claim 1, wherein the identifier is unique to the article.

4. The method of claim 1, further comprising the step of distributing the article in commerce before enabling the identifier.

5. The method of claim 1, wherein said article is selected from the group consisting of magazine inserts and warranty cards.

6. The method of claim 1, further comprising the steps of:
reading addressee information from the article; and
comparing the addressee information against address information associated with the identifier in the database.

7. The method of claim 6, further comprising the step of:
signaling when the addressee information differs from the address information associated with the identifier in the database.

8. The method of claim 6, further comprising the step of:
maintaining records associated with the identifier comparing step.

9. The method of claim 1, wherein the enabling step involves including an indication within a database that the identifier is valid, such that a later check of the identifier within the database returns a result showing that the identifier is valid.

10. The method of claim 1, further comprising the steps of:
delivering the article; and
charging a payer for sending the article upon the delivery of the article.

11. A method for sending an article in a postal system, said method comprising the steps of:
causing an identifier to be associated with address information in a database;
marking an article with the identifier; and
comparing the address information associated with the identifier with addressee information on the article before delivering the article.

12. The method of claim 11, wherein the identifier serves as postage for the article such that the article is only delivered when the identifier is enabled.

13. The method of claim 11, wherein the identifier is unique to the article.

14. The method of claim 11, further comprising the step of:
distributing the article in commerce before enabling the identifier.

15. The method of claim 11, wherein said article is selected from the group consisting of magazine inserts and warranty cards.

16. The method of claim 11, further comprising the steps of:
reading addressee information from the article; and
comparing the addressee information against address information associated with the identifier in the database.

17. The method of claim 16, further comprising the step of:
signaling when the addressee information differs from the address information associated with the identifier in the database.

18. The method of claim 16, further comprising the step of:
maintaining records associated with the identifier comparing step.

19. The method of claim 11, wherein the enabling step involves including an indication within a database that the identifier is valid, such that a later check of the identifier within the database returns a result showing that the identifier is valid.

20. The method of claim 11, further comprising the steps of:
delivering the article; and
charging a payer for sending the article upon the delivery of the article.

21. A system for tracking an article having an identifier and a recipient address, said system comprising:
a reader configured to read information from said article;
a database including identifier data associated with at least one identifier; and
means for retrieving data from the database and reviewing the data.

22. The system for tracking an article of claim 21, wherein said database further comprises data relating one or more identifiers to one or more recipient addresses and said system further comprises means for comparing the recipient address on said article against the identifier data in the database.

23. The system for tracking an article of claim 22, wherein said means for comparing the recipient address on said article comprises hardware configured to facilitate a comparison of the addressee indicator against the identifier data in the database.

24. The system for tracking an article of claim 22, wherein said means for comparing the recipient address on said article comprises software configured to facilitate a comparison of the addressee indicator against the identifier data in the database.

25. The system for tracking an article of claim 22, further comprising means for storing the results of the comparison of the recipient address against the identifier data in the database.

26. The system for tracking an article of claim 21, further comprising:
means for enabling said identifier; and
means for verifying enablement of said identifier.

27. The system for tracking an article of claim 21, wherein said reader comprises means for reading the identifier on said article.

28. The system for tracking an article of claim 21, further comprising means for charging a payer upon delivery of the article to the recipient of the article.

29. The system for tracking an article of claim 21, further comprising means for recording data in relation to operation of the system.

30. The system for tracking an article of claim 21, wherein said reader may read information which identifies a source of the article.

31. An article for use in a postal system, comprising:
an identifier associated with an addressee, wherein said identifier is indicated on said article and said identifier may alternate between being enabled and disabled in a database; and
said addressee being indicated on said article.

32. The article for use in a postal system of claim 19, wherein said identifier includes information which identifies a source of the article and said identifier is at least one of machine readable and human-readable.
